(19) United States
(12) Patent Application Publication
(10) Pub. No.: US 2017/0148555 A1
(43) Pub. Date: May 25, 2017

(54) MAGNETIZING DEVICE

(71) Applicant: LABORATORIO ELETTROFISICO ENGINEERING S.R.L., MILANO (IT)

(72) Inventor: Stefano TIZIANEL, Legnano (Milano) (IT)

(73) Assignee: LABORATORIO ELETTROFISICO ENGINEERING S.R.L., Milano (IT)

(21) Appl. No.: 15/358,934

(22) Filed: Nov. 22, 2016

(30) Foreign Application Priority Data
Nov. 25, 2015 (IT) 102015000076778

(51) Int. Cl. H01F 7/06; H01F 41/02; H01F 41/04; H01F 27/28; H01F 38/20

(52) U.S. Cl. CPC H01F 7/064; H01F 27/28; H01F 38/20; H01F 41/04; H01F 41/0206

(57) ABSTRACT

A magnetizing device, including an electric circuit composed of one or more branches arranged in series or in parallel, joined by nodes, so as to form multipolar magnetic geometries, powered directly or by means of a transformer by a capacitor-discharge magnetizer. Differently from the prior art, which provides for a single winding composed of a series of many turns wound specifically to form even more than one pole, the present invention combines multiple connections in series and in parallel which are localized, so as to minimize the leakage inductance of the system. The windings can therefore have even a low number of turns or even a single machine-made turn.

The present invention relates to a magnetizing device.

As is known, magnetizing coils are inductors which, when supplied with a current, generate a magnetic field that is used to magnetize permanent magnets.

Magnetizing coils are connected to a power supply which can be DC, AC, but is mostly CDU (Capacitor Discharging Unit).

Magnetizing coils can have various orientations: radial, circular, axial, Halbach, etc., and can have or not an iron core, which is useful to convey the lines of flux.

Coils can be cooled with water, air, oil, etc. and can be connected to the power supply directly or by means of a step-down or step-up transformer in order to increase their efficiency.

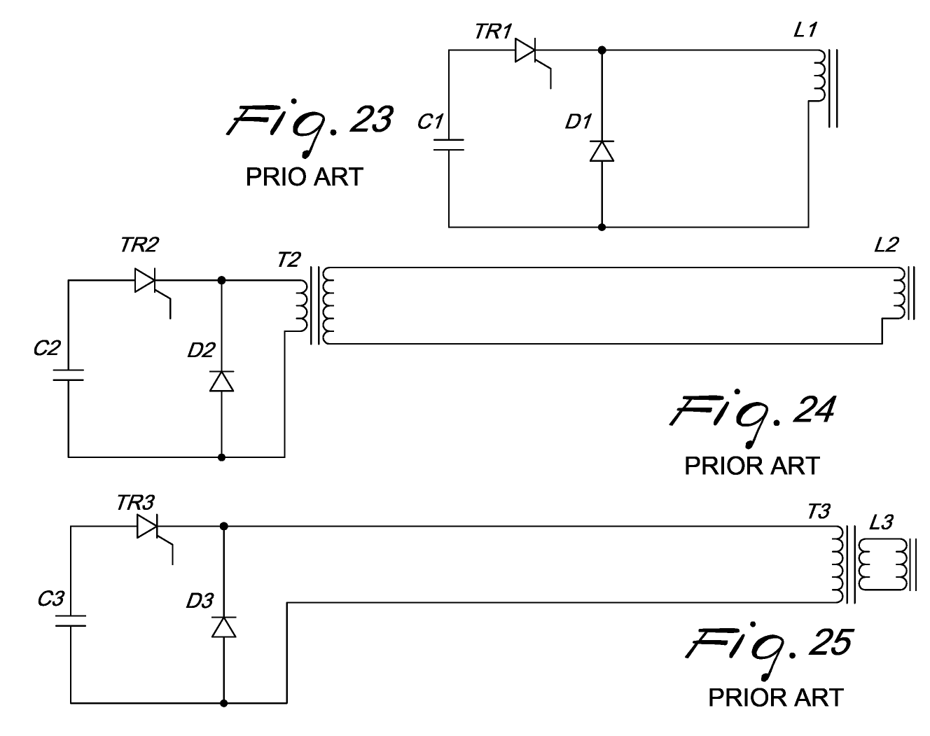

FIG. 23 shows a magnetizing coil, made according to the prior art, of the type with direct connection.

FIG. 24 shows a magnetizing coil, made according to the prior art, with connection by means of a step-up transformer, which increases the voltage across the secondary winding, for windings with many turns.

FIG. 25 shows a magnetizing coil, made according to the prior art, with connection by means of a step-down transformer that lowers the voltage across the secondary winding and increases the current, for windings with a small number of turns.

U.S. Pat. No. 4,470,031 discloses a device for magnetizing multipolar permanent magnet bodies. The device employs a supporting structure comprising apertures adapted to receive the electrically conductive magnetizing winding; the apertures are arranged to firmly support the winding to prevent displacement by the strong magnetic fields generated by a high-current impulse discharge; the winding can be arranged to produce a variety of polar patterns on flat magnets or, by providing a suitable opening in the supporting structure, on cylindrical magnets.

The conventional devices described above have a single winding composed of a set of many turns; the single winding can be wound in order to form also multiple poles.

The aim of the present invention is to provide a new type of magnetizing device that is advantageous with respect to conventional systems both_{—} in terms of construction and in terms of magnetic effectiveness.

Within the scope of this aim, an object of the invention is to provide a magnetizing device that can he used in various applications.

Another object of the invention is to provide a magnetizing device that is compact thanks to the fact that it uses small space for local redirection of the magnetizing field.

Another object is to provide a magnetizing device provided with a coil that can be machine-made.

A further important object of the present invention is to always ensure a high quality of construction that does not depend on the skill of the operator.

Another object of the present invention is to provide a device which, by virtue of its particular constructive characteristics, is capable of giving the greatest assurances of reliability and safety in use.

A further object of the present invention is to provide a device that is competitive from an economic standpoint.

This aim and these and other objects that will become better apparent hereinafter are achieved by a magnetizing device comprising a coil having a main conductor, connected to an input and wound in at least one turn forming at least two poles, and a secondary conductor, connected to an output and in parallel to said main conductor by means of at least one node.

Further characteristics and advantages will become better apparent from the description of preferred but not exclusive embodiments of the invention, illustrated by way of nonlimiting example in the accompanying drawings, wherein:

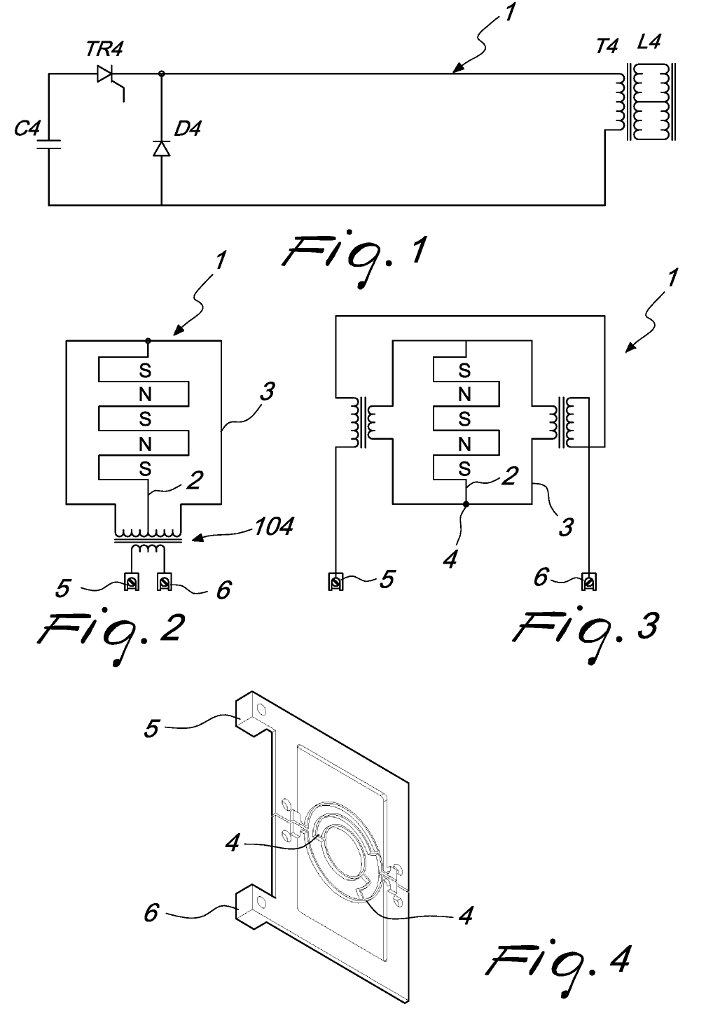

FIG. 1 is an electrical diagram of the magnetizing device according to the present invention, with connection by means of a step-down transformer;

FIG. 2 is a schematic view of the center tap of the transformer, used as a node;

FIG. 3 is a schematic view of the secondary windings of the transformer, used to open the branches;

FIG. 4 is an axonometric view of a ring magnetizing coil with two concentric tracks, with poles arranged with a non-fixed pitch;

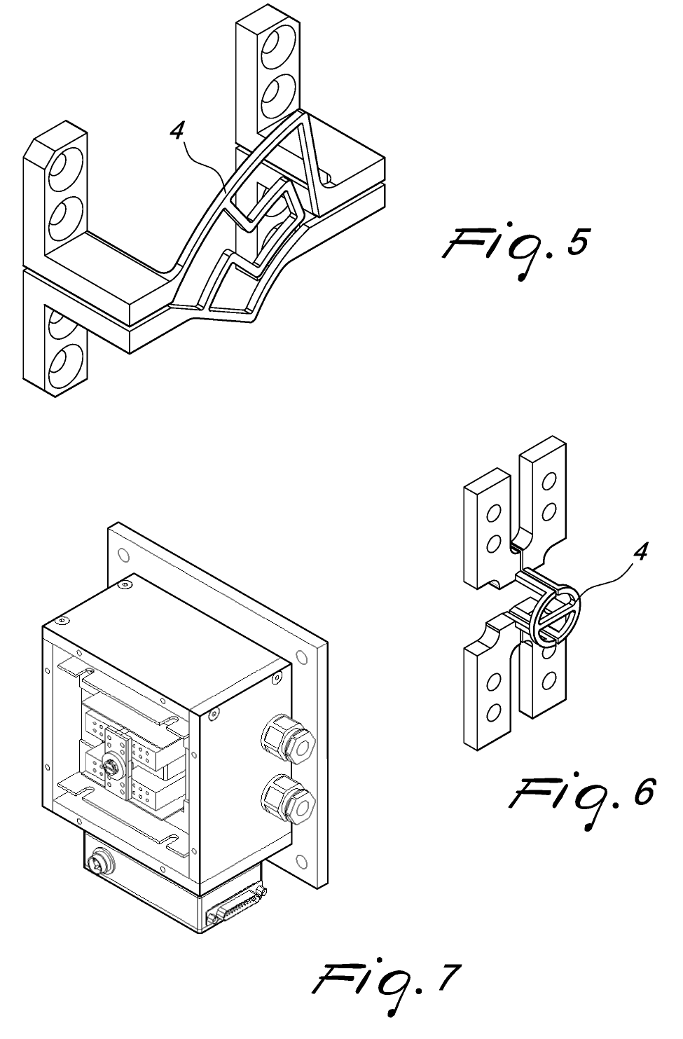

FIG. 5 is an axonometric view of a ring magnetizing coil with two incomplete concentric tracks, with poles arranged with a non-fixed pitch;

FIG. 6 is an axonometric view of a ring magnetizing coil with N/S axial magnetization;

FIG. 7 is a partial axonornetric view of a pulse transformer;

FIG. 8 is an axonometric view of an axial magnetizing coil with six poles;

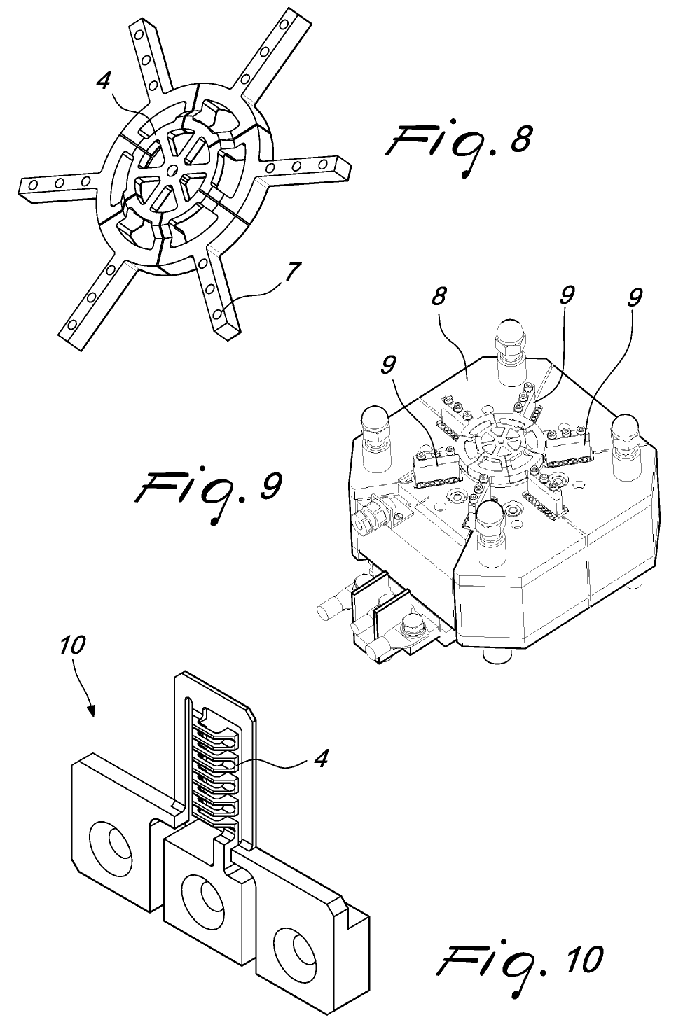

FIG. 9 is an axonometric view of a circular pulse transformer with six outputs;

FIG. 10 is an axonometric view of a linear axial magnetizing coil with eight poles;

FIG. 11 is an axonometric view of a linear pulse transformer with four outputs;

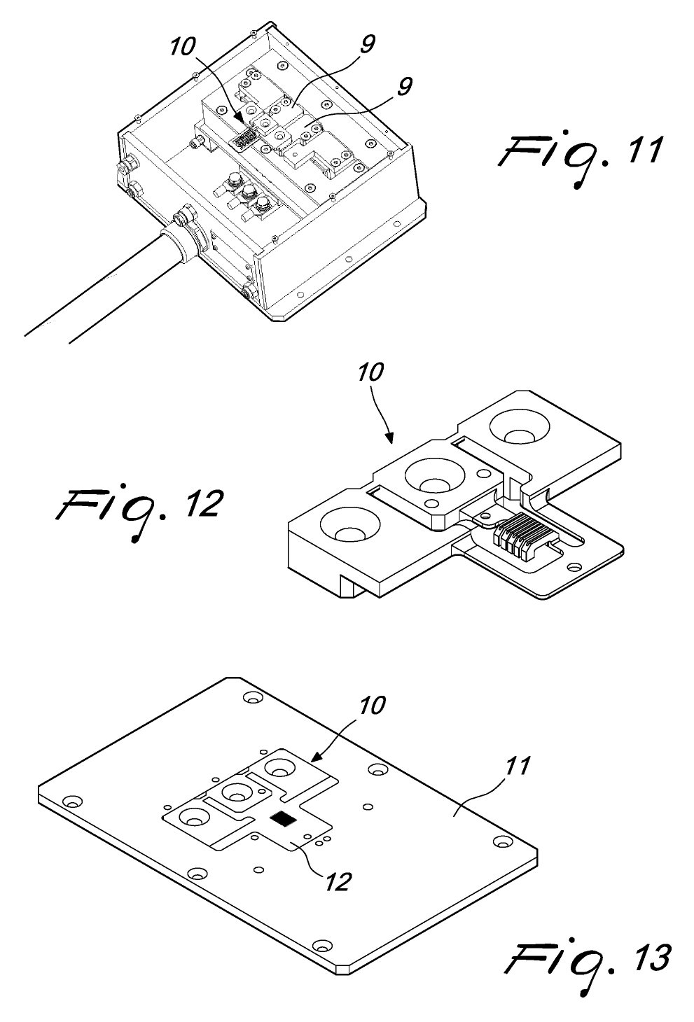

FIG. 12 is an axonometric view of a coil machined from solid copper;

FIG. 13 is an axonometric view of a coil mounted on the insulating support and embedded in resin;

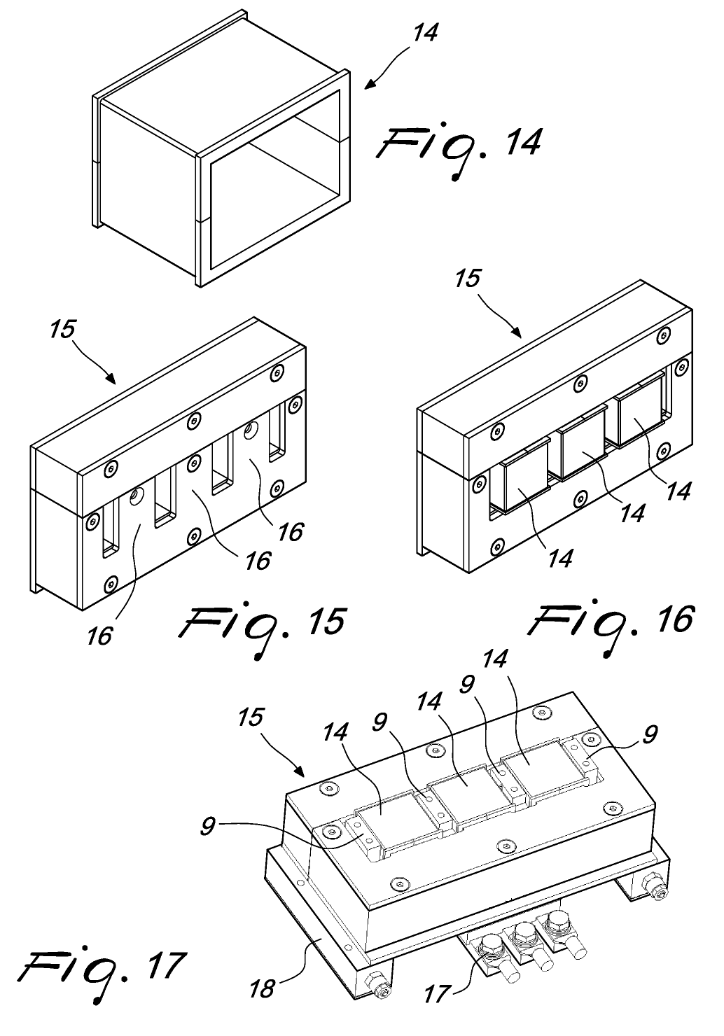

FIG. 14 is an axonometric view of a wound case;

FIG. 15 is an axonometric view of a laminated core;

FIG. 16 is an axonometric view of three cases mounted on three columns;

FIG. 17 is an axonometric view of a core with radiator, fixing terminals and secondary bars mounted thereon;

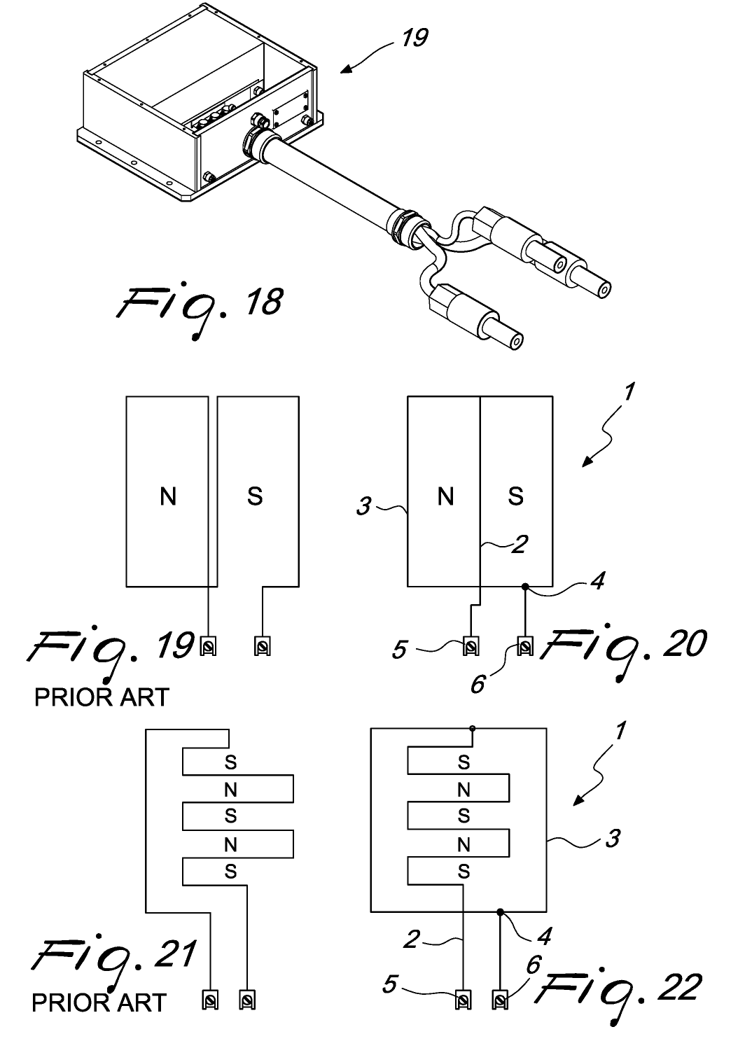

FIG. 18 is an axonometric view of a complete transformer without the magnetizing coil;

FIG. 19 is a simplified diagram of a device according to the prior art;

FIG. 20 is a simplified diagram of the device according to the present invention;

FIG. 21 is a simplified diagram of a prior art device;

FIG. 22 is a simplified diagram of the device according to the present invention;

FIG. 23 is a view of the connection of a magnetizing coil, made according to the prior art, of the type with direct connection;

FIG. 24 is a view of the connection of a magnetizing coil, made according to the prior art, with connection by means of a step-up transformer;

FIG. 25 is a view of a magnetizing coil, made according to the prior art, with connection by means of a step-down transformer.

With reference to the cited figures, the device according to the invention, globally designated by the reference numeral 1, comprises a coil having a main conductor 2, which is connected to an input 5 and is wound in at least one turn which forms at least two poles, an N pole and an S pole.

The coil also has a second conductor 3, which is connected to an output 6 and is connected in parallel to the main conductor 2 by means of at least one node 4.

FIG. 20 is a diagram of a bipolar axial coil, provided according to the invention, which shows that, contrary to the open branch of the prior art, shown in FIG. 19, the bipolar axial coil according to the present invention is closed.

FIG. 21 is a diagram of a multipolar axial coil with direct connection, according to the prior art, wherein the main conductor is contoured, obtaining a plurality of poles, depending on the number of folds. In the conventional coil, the N poles are higher than the S poles and a second layer would be necessary.

FIG. 22 is a diagram of a multipolar axial coil with direct connection, according to the present invention, wherein the N and S poles are balanced by means of the added branch 3.

FIGS. 1-3 are diagrams of the device according to the present invention having a multipolar axial coil with coupled connection, wherein the terminals of the secondary winding of the transformer are connected to a corresponding number of branches of the coil. This allows to create various branches that are independent at the secondary winding but are mutually joined.

FIG. 1 shows a connection by means of a step-down transformer which lowers the voltage across the secondary winding and increases the current.

The diagram of FIG. 2 shows an embodiment of the invention wherein the center tap of the transformer is used as a node.

The diagram of FIG. 3 shows an embodiment of the invention wherein the secondary windings of the transformer are used to open the branches.

FIG. 4 shows an embodiment of a ring magnetizing coil with two concentric tracks, with poles arranged with a non-fixed pitch.

This configuration has various advantages with respect to the conventional coil structure.

An advantage is constituted by the fact that only the part that is useful for magnetizing has a reduced cross-section, while the remainder has a large cross-section, with a consequent reduction of resistance.

Also, the nodes do not require the complicated series connection.

An important advantage is that the coil can be machine-made and the quality of its construction does not depend on the skill of the operator.

A further advantage is that it is possible to shape the cross-sections as desired.

The coil connected to a transformer, according to the present invention, has all the advantages described above regarding the coil with direct connection and the following additional advantages with respect to the prior art: a reduction of the voltage across the secondary winding, a much less onerous insulation, and the possibility to use a same transformer, being able to change only part of the secondary winding, with consequent economic advantages from the point of view of production.

FIG. 5 is a view of an embodiment of a ring magnetizing coil with N/S axial magnetization, according to the present invention.

FIG. 6 is a view of an embodiment of a ring magnetizing coil with two incomplete concentric tracks, with poles arranged with a non-fixed pitch.

FIG. 7 is a perspective view of a pulse transformer.

FIG. 8 is a view of an embodiment of an axial magnetizing coil with six poles, in which the reference numeral 4 designates a node and the reference numeral 7 designates the contacts of the secondary winding.

FIG. 9 is an axonometric view of a circular pulse transformer with six outputs, showing the iron core 8 and the bars of the secondary winding 9.

FIG. 10 shows an embodiment of an axial magnetizing coil with eight poles, globally designated by the reference numeral 10.

FIG. 11 is an axonometric view of a linear pulse transformer with four outputs, provided with the coil 10 of the preceding figure, and in which the bars of the secondary winding 9 are visible.

The coil is formed from a solid copper block by machining by means of a tool or electrical discharge, leaving stock in order to keep the various parts in the correct position.

The coil is then mounted on a support 11, with the appropriate solutions for centering. If provided, the iron core is inserted between the conductors. The entire assembly is poured in epoxy resin 12 in a cold environment or by means of a press for thermosetting materials.

When the resin has cooled and hardened, the stock is removed by milling and then the coil is opened, removing the short-circuit.

FIG. 12 shows the machined coil made of solid copper, while FIG. 13 shows the coil mounted in the insulating support 11 and embedded in the resin 12.

The transformer includes a primary circuit and half of the secondary circuit.

The primary circuit includes a plurality of cases 14 made of insulating material, which are wound with a corresponding number of turns of enameled copper.

The wound cases are mounted on columns 16 of a laminated core 15.

FIG. 14 is an axonometric view of a wound case 14.

FIG. 15 is a view of the laminated core 15 and FIG. 16 shows three cases 14 mounted on three columns of the laminated core 15.

The cases 14 are connected at the connection terminals 17 to the magnetizer.

A water radiator 18 is mounted on the iron core. The bars of the secondary winding 9 are inserted between one case 14 and the other.

FIG. 17 is an axonometric view of the core 15 with the radiator 18, the fixing terminals 17 and the bars of the secondary winding 9 mounted thereon.

The entire structure is then inserted in a pouring template and filled with epoxy resin, which hardens in a cold environment in vacuum.

FIG. 18 is an axonometric view of the complete transformer, globally designated by the reference numeral 19. ,

In practice it has been found that the invention achieves the intended aim and objects, providing a magnetizing device in which the magnetizing coil is built by combining a parallel connection with a series connection so as to minimize the leakage inductance of the system.

The windings can be provided with a low number of turns or even with a single machine-made turn.

The structure according to the present invention offers numerous and important advantages with respect to the prior art, which provides for a single series winding composed of a series of many turns in order to form even multiple poles.

This application claims the priority of Italian Patent Application No. UB2015A005892 (corresponding to 102015000076778), filed on Nov. 25, 2015, the subject matter of which is incorporated herein by reference.

1. A magnetizing device comprising a coil having a main conductor, connected to an input and wound in at least one turn forming at least two poles, and a secondary conductor, connected to an output and in parallel to said main conductor by means of at least one node.

2. The magnetizing device according to claim 1, wherein said main conductor is contoured and forms a plurality of poles.

3. The magnetizing device according to claim 2, wherein said coil is axial and multipolar with a coupled connection and comprises secondary conductor terminals that are connected to a corresponding number of branches of said coil.

4. The magnetizing device according to claim 1, comprising a step-down transformer.

5. The magnetizing device according to claim 4, wherein said transformer comprises a center tap, said center tap being used as a node.

6. The magnetizing device according to claim 4, wherein said transformer comprises secondary conductors, said secondary conductors being used to open the branches of said coil.

7. The magnetizing device according to claim 1, comprising a ring magnetizing coil with two concentric tracks, with poles arranged at a non-fixed pitch.

8. The magnetizing device according to claim 1, comprising a transformer comprising a primary circuit and a part of a secondary circuit; said primary circuit comprising a plurality of cases, made of insulating material, wound with a corresponding number of turns of enamel-insulated copper; said wound cases being mounted on columns of a laminated core; said cases being connected to terminals for connection to a magnetizer; said device furthermore comprising a radiator that is mounted on said core; said secondary circuit comprising bars arranged between said cases.

9. A method for manufacturing a magnetizing device according to claim 1, comprising the steps of:
forming said coil starting from a solid copper block by means of machining by stock removal with a tool or with electrical discharge machining, leaving stock;
mounting said coil on a support;
pouring the entire assembly in epoxy resin in a cold environment or by means of a press for thermosetting materials;
when the resin has cooled and hardened, removing said stock by milling and opening said coil, removing any short-circuits.

10. The method according to claim 9, comprising a step of inserting said core between one conductor and the other.
